(19) United States
(12) Patent Application Publication
(10) Pub. No.: US 2020/0084984 A1
(43) Pub. Date: Mar. 19, 2020

(54) Combination of the vortex tube and an aeroponic or hydroponic system, for achievement of internal climate-control within the system

(71) Applicant: Isidoro Adrian Brunori, Toms River, NJ (US)

(72) Inventor: Isidoro Adrian Brunori, Toms River, NJ (US)

(21) Appl. No.: 16/132,401

(22) Filed: Sep. 15, 2018

(51) Int. Cl. A01G 31/02

(52) U.S. Cl. CPC A01G 31/02

(57) ABSTRACT

The vortex tube mated to a hydroponic system creates an internal climate-controlled environment. The technical advantage is in providing a cost-effective climate control mechanism. By controlling the internal climate of the system, we can extend the grow season in a cost-effective way. Climate controlling large buildings is very costly and traditional greenhouses have little or no climate control. The commercial advantage is the ability to provide product in a counter cyclical manner to the commodities market. Meaning, traditional crops all come to the commodities market at the same time and cannot command a higher price. Providing product when it is normally not available or has to be imported, provides the best opportunity to command higher prices. This is key to the economic viability of the venture and provides benefit to the consumer.

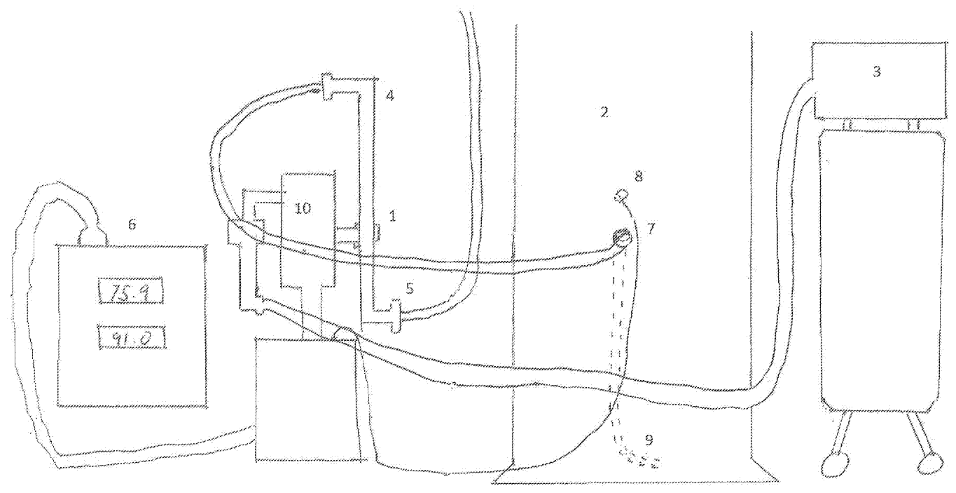

### SUMMARY

The combination of the vortex tube and the hydroponic system provides the ability to internally control the temperature in the hydroponic system. Year-round growing is commonly achieved through indoor grow operations by maintaining a stable climate in the entire facility, which is cost prohibitive for large-scale adoption and provides a poor economic return. Hydroponic systems in greenhouses, have no climate control and the grow season is limited to certain times of the year. By controlling the temperature, inside the system, we can extend the grow season for minimal additional cost. We also can produce product at times when it is not available from the local market. This adds to the economic viability, in that crops produced locally with this procedure, compete against crops that must be imported from long distances. Thus, the combination of these two existing systems provides a way to produce crops year-round in a cost-effective way.

### DESCRIPTION OF INVENTION

The vortex tube intakes compressed air and spins it, producing very cold air out of one end and very hot air out of the other. The air of the preferred temperature is piped into the liquid inside the hydroponic tank, moderating the temperature of both the water and air. The other type of air is vented and does not interact with the system. An electronic thermometer is placed inside the system. When the system reaches the desired internal temperature, the air solenoid shuts off the compressor. The thermometer triggers the air solenoid to restart the compressor, whenever the system is out of the desired temperature range. Thus, maintaining a stable temperature inside the system.

### DESCRIPTION OF DRAWINGS

1) Vortex Tube—Intakes compressed and spins it in the vortex, exhausting both hot and cold air.

2) Hydroponic or aeroponic unit—Has a reservoir tank that periodical or continuously feeds water and nutrients to the grow cups which contain the vegetation.

3) Compressor and tank—Generates and holds compressed air for feeding to the vortex tube.

4) Cold air exhaust—Both cold and hot air are generated by the vortex tube. In this instance we are cooling the system, so the cold air hose is connected to the system. In cold weather or for warm weather crops, we reverse the configuration and connect the hot air to the system.

5) Hot air exhaust—In this instance, the hot air is vented away from the system and discarded. In cold weather scenarios, the cold air will be vented away from the system and discarded.

6) Hemostat—Desired temperature range is set by the user. When the temperature is out of range, the thermostat triggers the air solenoid to open the valve allowing the vortex tube to intake the compressed air.

7) Air intake to the hydroponic or aeroponic system—This connection, feeds internal air discharge hose #9.

8) Thermostat sensor—The sensor monitors the temperature inside the system and relays it to the thermostat.

9) Internal air discharge hose—The hose exhaust is placed at the bottom of the liquid reservoir to induce bubbling inside the liquid, thus conditioning the liquid and air to the desired temperature.

10) Air Solenoid—The air solenoid restricts intake of compressed air to the vortex tube. The air solenoid allows compressed air into the vortex tube until the desired temperature is reached by the thermostat and the thermostat then closes the air solenoid.

1. A method of achieving internal climate control of a hydroponic or aeroponic growing system comprising:
a) a compressor that feeds compressed air to a vortex tube which spins the air producing both hot and cold air and
b) an air solenoid which restricts compressed air flow to the vortex tube and
c) a thermostat that is set at a desired temperature which opens the air solenoid releasing the compressed air to the vortex tube when the internarial temperature of the hydroponic or aeroponic unit is out the set temperature parameters and
d) either the hot air or cold air is fed into the system, depending on the desired effect and
Whereby internal climate control of both liquid and air in the hydroponic or aeroponic system is achieved.
